(19) United States
(12) Patent Application Publication
(10) Pub. No.: US 2024/0057642 A1
(43) Pub. Date: Feb. 22, 2024

(54) BEVERAGES COMPRISING REB A AND STEVIOL GLYCOSIDES

(71) Applicant: CORN PRODUCTS DEVELOPMENT, INC., WESTCHESTER, IL (US)

(72) Inventors: Akshay ANUGU, Bridgewater, NJ (US); Andrea BELFORD, Bridgewater, NJ (US); Christopher GREGSON, Bridgewater, NJ (US); Kaitlin DIBLASIO, Bridgewater, NJ (US); Kevin SYMCZAK, Bridgewater, NJ (US); Kasi SUNDARESAN, Bridgewater, NJ (US); Robert WANSOR, Bridgewater, NJ (US)

(21) Appl. No.: 18/270,312

(22) PCT Filed: Dec. 30, 2021
(86) PCT No.: PCT/US2021/065723

§ 371 Date: Jun. 29, 2023

Related U.S. Application Data
(60) Provisional application No. 63/132,202, filed on Dec. 30, 2020.

(51) Int. Cl. A23L 2/60; A23L 27/30

(52) U.S. Cl. CPC A23L 2/60; A23L 27/36

(57) ABSTRACT

Disclosed herein are beverages and throw syrups comprising Reb A, and at least one foam suppressing agent comprising Reb E, stevioside, rubusoside, Reb C, or any combination thereof.

Disclosed herein are beverages and throw syrups comprising Reb A and at least one foam suppressing agent comprising Reb E, stevioside, rubusoside, Reb C, or any combination thereof.

Natural caloric sugars, such as sucrose, fructose and glucose, are utilized to provide a pleasant taste to food and beverages. Sucrose, in particular, imparts a taste preferred by consumers. Although sucrose provides superior sweetness characteristics, it is caloric. Non-caloric or low caloric sweeteners have been added to food and beverages, such as carbonated beverages, to satisfy consumer demand.

For example, Reb A, one of the steviol glycosides from stevia plant has been used in place of sucrose. However, Reb A causes excessive and persistent foaming in beverages, particularly in carbonated beverages. Such foaming problems can significantly increase cost and time, and reduce throughput volumes. Further, foaming of carbonated beverages during manufacturing leads to loss of CO₂ during filling. Therefore, containment and inhibition of foam is necessary in beverage processing for improved efficiency.

Commonly used anti-foam agents include insoluble oils, polydimethylsiloxanes and other silicones, certain alcohols, stearates and glycols. These agents have practical limitations, including poor organoleptic properties. Further, many de-foaming agents are not natural. Therefore, there remains a need to develop beverage and throw syrup compositions containing Reb A, in which foaming is suppressed using natural agents with desirable organoleptic properties.

The disclosure provides beverages comprising Reb A, and at least one foam suppressing agent comprising Reb E, stevioside, rubusoside, Reb C, or any combination thereof, wherein the beverage has one or more of the following characteristics: (i) a foam height that is less than a foam height of a RebA control beverage by at least about 1%, and (ii) a foam stability that is less than a foam stability of the RebA control beverage by at least about 1%. In some embodiments, the beverage has a foam height that is less than a foam height of a RebA control beverage by at least about 1%. In some embodiments, the beverage has a foam stability that is less than a foam stability of the RebA control beverage by at least about 1%. In some embodiments, the beverage has a foam height that is less than a foam height of a RebA control beverage by at least about 1% and wherein the beverage has a foam stability that is less than a foam stability of the RebA control beverage by at least about 1%.

In some embodiments, the beverage is a carbonated beverage. In some embodiments, the beverage is a non-carbonated beverage. In some embodiments, the beverage has a pH in the range of about 2.2 to about 7.5. In some embodiments, the foam height of the beverage is less than the foam height of the Reb A control beverage by about 1% to about 50%. In some embodiments, the foam stability of the beverage is less than the foam stability of the Reb A control beverage by about 1% to about 70%. In some embodiments, the beverage provides a Brix in the range of about 0.5 to about 14 in terms of sucrose.

In some embodiments, Reb A is present in a concentration of about 100 ppm to about 700 ppm. In some embodiments, the at least one foam suppressing agent is present in a concentration of about 1 ppm to about 300 ppm. In some embodiments, the at least one foam suppressing agent is present in a concentration of about 25 ppm to about 100 ppm. In some embodiments, the at least one foam suppressing agent is present in an amount of about 0.0001% v/v to about 0.1% v/v. In some embodiments, the ratio of Reb A to the at least one foam suppressing agent ranges from about 20:1 to about 1:5.

In some embodiments, the beverage comprises Reb A and Reb E. In some embodiments, Reb E is present in a concentration ranging from about 1 ppm to about 200 ppm. In some embodiments, Reb E is present in a concentration of about 25 ppm to about 100 ppm. In some embodiments, Reb E is present in an amount of about 0.0001% v/v to about 0.1% v/v. In some embodiments, the ratio of Reb A to Reb E ranges from about 20:1 to about 1:5.

In some embodiments, the beverage comprises Reb A and Reb C. In some embodiments, Reb C is present in a concentration ranging from about 1 ppm to about 200 ppm. In some embodiments, Reb C is present in a concentration of about 25 ppm to about 100 ppm. In some embodiments, Reb C is present in an amount ranging from about 0.0001% v/v to about 0.1% v/v. In some embodiments, the ratio of Reb A to Reb C ranges from about 20:1 to about 5:1.

In some embodiments, the beverage comprises Reb A and stevioside. In some embodiments, stevioside is present in a concentration ranging from about 1 ppm to about 200 ppm. In some embodiments, stevioside is present in a concentration of about 25 ppm to about 100 ppm. In some embodiments, stevioside is present in an amount of about 0.0001% v/v to about 0.1% v/v. In some embodiments, the ratio of Reb A to stevioside ranges from about 20:1 to about 1:5.

In some embodiments, the beverage comprises Reb A and rubusoside. In some embodiments, rubusoside is present in a concentration ranging from about 1 ppm to about 200 ppm. In some embodiments, rubusoside is present in a concentration of about 25 ppm to about 100 ppm. In some embodiments, rubusoside is present in an amount ranging from about 0.0001% v/v to about 0.1% v/v. In some embodiments, the ratio of Reb A to rubusoside is about 20:1 to about 5:1.

The disclosure provides beverages comprising Reb A, and at least one foam suppressing agent, comprising Reb E, stevioside, rubusoside, Reb C, or any combination thereof, wherein Reb A is present in a concentration of about 100 ppm to about 700 ppm and wherein the at least one foam suppressing agent is present in a concentration of about 25 ppm to about 300 ppm. In some embodiments, the beverage has a foam height that is less than a foam height of a Reb A control carbonated beverage by about 1% to about 50%. In some embodiments, the beverage has a foam stability that is less than a foam stability of the Reb A control carbonated beverage by about 1% to about 70%. In some embodiments, the beverage is carbonated. In some embodiments, the at least one foam suppressing agent is present in a concentration of about 25 ppm to about 100 ppm. In some embodiments, the at least one foam suppressing agent is Reb E.

The disclosure provides throw syrups comprising Reb A, and at least one foam suppressing agent comprising Reb E, stevioside, rubusoside, Reb C, or any combination thereof, wherein Reb A is present in a concentration of about 500 ppm to about 7000 ppm, and wherein the at least one foam suppressing agent is present in a concentration of about 5 ppm to about 1000 ppm. In some embodiments, the at least one foam suppressing agent is present in a concentration of about 125 ppm to about 1000 ppm. In some embodiments, when the throw syrup is added to a liquid medium to form a beverage, the beverage has one or more of the following characteristics: (i) a foam height that is less than a foam height of a Reb A control beverage by at least about 1%; and (ii) a foam stability that is less than a foam stability of the RebA control beverage by at least about 1%.

In some embodiments, the beverage is a carbonated beverage and the RebA control beverage is a RebA control carbonated beverage. In some embodiments, the beverage has a pH in the range of about 2.2 to about 7.5. In some embodiments, the beverage has a Brix in the range of about 0.5 to about 14 in terms of sucrose. In some embodiments, the throw syrup comprises Reb E. In some embodiments, the throw syrup comprises stevioside. In some embodiments, the throw syrup comprises rubusoside. In some embodiments, the throw syrup comprises Reb C. In some embodiments, the beverage has a foam height that is less than a foam height of a Reb A control carbonated beverage by about 1% to about 50%. In some embodiments, the beverage has a foam stability that is less than a foam stability of the Reb A control carbonated beverage by about 1% to about 70%.

### BRIEF DESCRIPTION OF DRAWINGS

FIG. 1A shows a comparison of the average foam height of beverages containing Reb A and beverages containing Reb A and at least one foam suppressing agent, as described in Example 1. FIG. 1B shows a comparison of the average foam stability of beverages containing Reb A and beverages containing Reb A and at least one foam suppressing agent, as described in Example 1. The values with the asterisk represent the percent change in foam height and stability relative to the Reb A control.

FIG. 2A shows a comparison of the average foam height of beverages containing Reb A and beverages containing Reb A and at least one foam suppressing agent prepared using a throw syrup, as described in Example 2. FIG. 2B shows a comparison of average foam stability of beverages containing Reb A and beverages containing Reb A and at least one foam suppressing agent prepared using a throw syrup, as described in Example 2. The values with the asterisk represent the percent change in foam height and stability relative to the Reb A control.

### DEFINITIONS

It is to be understood that the terminology used herein is for the purpose of describing particular embodiments only and is not intended to be limiting.

Unless defined otherwise, all technical and scientific terms used herein have the same meaning as commonly understood by one of ordinary skill in the art to which the present application belongs. Although any methods and materials similar or equivalent to those described herein can be used in the practice or testing of the present application, representative methods and materials are herein described.

Following long-standing patent law convention, the terms “a”, “an”, and “the” refer to “one or more” when used in this application, including the claims. Thus, for example, reference to “a foam suppression agent” includes mixtures of one or more foam suppression agent, two or more foam suppression agent.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the present application. Generally, the term “about”, as used herein in references to a measurable value such as an amount of weight, time, dose, etc. is meant to encompass values within an acceptable degree of variability in the art.

As used herein, “foam suppressing agent” refers to an agent that when added to a “Reb A control beverage” or a “Reb A control carbonated beverage,” can reduce the foam height and/or foam stability of the “Reb A control beverage” or the “Reb A control carbonated beverage” respectively by at least about 0.5%. While the foam suppressing agents disclosed herein can impart sweetness on a beverage when present at sufficiently high concentrations, in some embodiments of the disclosure the foam suppressing agents are not present in the beverages described herein at such high concentrations so as to impart significant sweetness. In some embodiments, the foam suppression agents disclosed herein independently (i.e., in the absence of Reb A) provide a sweetness equivalent to degree Brix that is less than or equal to about 2.0, less than or equal to about 1.5, less than or equal to about 1.0, less than or equal to about 0.5, less than or equal to about 0.4, less than or equal to about 0.3, less than or equal to about 0.2, less than or equal to about 0.1, or any value or range therebetween (e.g., ranging from about 2.0 to 0 Brix, from about 2.0 to 0.5 Brix from about 1.5 to about 0.1 Brix). In some embodiments, the foam suppression agents disclosed herein are present at a concentration of less than or equal to about 400 ppm, about 375 ppm, about 350 ppm, about 325 ppm, about 300 ppm, about 275 ppm, about 250 ppm, about 225 ppm, about 200 ppm, about 175 ppm, about 150 ppm, about 125 ppm, about 100 ppm, about 75 ppm, about 60 ppm, about 50 ppm, or less.

As used herein, the term “steviol glycoside(s)” refers to glycosides of steviol, including, but not limited to, naturally occurring steviol glycosides, e.g. Rebaudioside A (Reb A), Rebaudioside B (Reb B), Rebaudioside C (Reb C), Rebaudioside D (Reb D), Rebaudioside E (Reb E), Rebaudioside F (Reb F), Rebaudioside X (Reb X), Rebaudioside (Reb M), Stevioside, Steviolbioside, DulcosideA, Rubusoside, etc. or synthetic steviol glycosides.

Naturally occurring steviol glycosides may be purified from a stevia extract, which in turn is obtained by extraction from stevia dry leaves and purification. Stevia is a composite perennial plant native to Paraguay in South America, and its scientific name is Stevia Rebaudiana Bertoni. Recently, the steviol glycosides have also been extracted from the varietal Stevia Rebaudiana Morita. Some steviol glycosides have about 300 times or more the sweetness of sugar and therefore may be used in beverages as a natural sweetener. Among various Rebaudiosides, Reb A is widely used due to high sweetness and relative abundance. Steviol glycosides, including rebaudiosides may be synthesized chemically or enzymatically, or extracted from a stevia extract. For example, Rebaudiosides may be purified according to methods described in Japanese Patent Domestic Announcement No. 2009-517043, U.S. Pat. No. 8,414,949, and Foods 2014, 3(1), 162-175; doi: 10.3390/foods3010162, or U.S. Pat. No. 7,838,044, the contents of each of which are incorporated herein by reference in their entireties for all purposes. Additionally, steviol glycosides may be analyzed by methods well known in the art, for example, by a high-performance liquid chromatograph (HPLC) set under conditions described in Japanese Patent Domestic Announcement No. 2012-504552.

As used herein, “beverage” refers to any drinkable liquid or semi-liquid, including for example flavored water, soft drinks, fruit drinks, coffee-based drinks, tea-based drinks, juice-based drinks, milk-based drinks, carbonated or non-carbonated drinks, alcoholic or non-alcoholic drinks, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer.

As used herein, a “Reb A control beverage” is a beverage that consists of water and Reb A, wherein the concentration of Reb A in the control beverage is equal to the concentration of Reb A in the comparator beverage comprising Reb A and one or more foam suppressing agent. For example, when a beverage of the disclosure comprises about 600 ppm of Reb A and one or more foam suppressing agents, the control beverage similarly has about 600 ppm of Reb A. To be clear, the Reb A control beverage does not comprise any of the following foam suppressing agents: Reb E, stevioside, rubusoside, and Reb C.

As used herein, “carbonated beverage” refers to a beverage comprising carbon dioxide gas. Examples of the carbonated beverage include sodas, nonalcoholic beverages, and alcoholic beverages. Specific examples include, but are not limited to, sparkling beverages, cola, diet cola, ginger ale, soda pop, and carbonated water provided with a fruit juice flavor.

As used herein, a “Reb A control carbonated beverage” is a beverage that consists of water, Reb A, and carbon dioxide, wherein the concentration of Reb A and carbon dioxide in the control beverage is equal to the concentration of Reb A and carbon dioxide in the comparator beverage comprising Reb A and one or more foam suppressing agent. For example, when a beverage of the disclosure comprises about 300 ppm Reb A; carbon dioxide in an amount (g) such that about 1 liter bottle of beverage at 3.8 gas volume contains 7.5 g of CO₂; and one or more foam suppressing agents; the control beverage contains about 300 ppm Reb A and the same amount of carbon dioxide. To be clear, the Reb A control carbonated beverage does not include any of the following foam suppressing agents: Reb E, stevioside, rubusoside, and Reb C. Further details about the volumes of carbon dioxide used in carbonated beverages are provided in The “Soft Drinks Companion: A Technical Handbook by Maurice Shachman” 2005, Pages 167-177, the contents of which are incorporated herein by reference in its entirety for all purposes.

As used herein, Brix refers to the sugar content of an aqueous solution in terms of sucrose. One degree Brix is 1 gram of sucrose in 100 grams of solution. Brix of a steviol glycoside (e.g., Reb A) may be calculated from the degree of sweetness relative to sucrose using a flavor panel. For example, Reb A is about 300 times the sweetness of sucrose; therefore, the amount of Reb A equivalent to Brix 1 in terms of sucrose is about 33.3 ppm Reb A. Sweetness equivalent in Brix of the Reb E, stevioside, rubusoside, and Reb C can be calculated similarly from the concentration response as determined using a flavor panel. Approximate relative sweetness values for sweeteners that may be used as alternatives to sucrose are listed in Table 1.1 of “Alternative Sweeteners” 4th Edition, Lyn O'Brien-Nabors CRC Press, published Oct. 26, 2016, ISBN 9781138198562—CAT #K31388. The contents of this reference are incorporated herein by reference in its entirety for all purposes.

As used herein, “foam height”, used interchangeably with “foam volume,” is the height of the foam of a beverage, measured by the “foam height assay,” which is performed in the following manner. The sample beverage used in the assay is stored in a 10 oz glass bottle at 40° F. overnight until the assay is performed. A 1000 mL graduated cylinder is rinsed with distilled water. The 1000 mL graduated cylinder is placed upside down, over the neck of the bottle containing the beverage to create a tight seal. When ready for measurements, the graduated cylinder is quickly inverted with the bottle attached to its neck, to allow all the liquid to pour out from the bottle into the graduated cylinder. Once the beverage is completely poured from the bottle, the foam height is recorded, which corresponds to the difference between the reading for the foam/air interface and the reading for the liquid/foam interface. Measurement of foam volume is also described in U.S. application Ser. No. 12/563,261, which is incorporated as a reference in its entirety. For non-carbonated beverages, a tissue-tearor method may be used for preparing the beverage, as described below and in Example 1. The beverage formulation is placed in a centrifuge tube and subjected to medium shear with a tissue tearor for a defined amount of time. After the mixing stops, foam height and/or foam stability is recorded. The results from tissue tearor the measurement of foam height correlate with industry standards.

As used herein, “foam stability” is a measure of the length of time that foam completely covers the top of a beverage. Foam stability is measured by the “foam stability assay,” which is performed in the following manner. At the time of measuring the “foam height” as described above, a timer is started to measure the foam stability. When a break in the foam forms at the top of the beverage, such that the beverage can be seen from the top of the cylinder, the timer is stopped. The time measured is recorded as the “foam stability.”

As used herein, “throw syrup” or “concentrated syrup” refers to a composition comprising a concentrated amount of Reb A in a volume of liquid medium that is less than the volume of liquid medium found in a finished beverage. The throw syrup is combined with a liquid medium to constitute the finished beverage. The throw syrup may optionally comprise flavoring agents, coloring agents, and other additives such as food-grade acids and preservatives. The reduced volume of liquid medium in the throw syrup allows for reduced storage and shipping costs; and increased shelf life. In some embodiments, the throw syrup is formulated to provide final beverage compositions upon dilution with about a 2-fold to about a 10-fold by volume, for example, 3-fold, 4-fold, 5-fold, 6-fold, 7-fold, 8-fold, or 9-fold by volume, of a liquid medium.

As used herein, “liquid medium” or “liquid matrix” is the basic ingredient of the beverages or throw syrups disclosed herein in which the ingredients—including Reb A and at least one foam suppressing agent—are dissolved. Non-limiting examples of liquid medium include water, sparkling water, club soda, seltzer water, sparkling mineral water, deionized water, distilled water, reverse osmosis water, carbon-treated water, purified water, demineralized water, phosphoric acid, phosphate buffer, citric acid, citrate buffer, carbon-treated water, juice, gel drinks, coffee, tea, milk or any other daily product, anon-dairy product, alcohol component, or any combination thereof. The liquid medium may be carbonated or non-carbonated.

### Beverages Comprising RebA and Foam Suppressing Agents

The disclosure provides beverages comprising Reb A, and at least one foam suppressing agent. In some embodiments, the foam suppressing agent is a steviol glycoside. In some embodiments, the foam suppressing agent is Reb E, stevioside, rubusoside, Reb C, or any combination thereof. As discussed herein, Reb A is currently being used in beverages as a non-caloric, natural alternative to sucrose. However, Reb A causes excessive and persistent foaming in beverages. While Reb E, stevioside, rubusoside, and Reb C are also used as sweeteners in beverages, the inventors have surprisingly discovered that these steviol glycosides also suppress the foam height and/or foam stability beverages containing Reb A, thereby counteracting the foaming issues observed in beverages containing Reb A.

In some embodiments, the beverages disclosed herein have a foam height that is less than a foam height of a RebA control beverage by at least about 1%. In some embodiments, the foam height of the beverage disclosed herein is less than the foam height of the RebA beverage by at least about 5%. In some embodiments, the foam height of the beverage disclosed herein is less than the foam height of the RebA control beverage by about 0.1% to about 100%, for example, about 0.5%, about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, including all values and subranges that lie therebetween.

In some embodiments, the beverages disclosed herein have a foam stability that is less than a foam stability of a Reb A control beverage by at least about 1%. In some embodiments, the foam stability of the beverage disclosed herein is less than the foam stability of the Reb A control beverage by at least about 5%. In some embodiments, the foam stability of the beverages disclosed herein is less than the foam stability of the Reb A control beverage by about 0.1% to about 100%, for example, about 0.5%, about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, including all values and subranges that lie therebetween.

In some embodiments, the Reb A control beverage is a Reb control carbonated beverage.

In some embodiments, the beverage provides a Brix in the range of from about 0.5 to about 14 in terms of sucrose; for example, a Brix of about 1, about 1.5, about 2, about 2.5, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5 or about 14, in terms of sucrose, inclusive of all values and subranges that lie therebetween. In some embodiments, the beverage provides a Brix in the range of from about 11 to about 12 in terms of sucrose. In some embodiments, the beverage has a Brix in the range of from about 10 to about 12. In some such embodiments, the beverage is a carbonated beverage. In some embodiments, the beverage has a Brix in the range of from about 5 to about 10, or from about 5 to about 8. In some such embodiments, the beverage is a fruit juice. In some embodiments, the beverage has a Brix in the range of from about 5 to about 13.5. In some such embodiments, the beverage is an energy drink or a sports drink. In some embodiments, the beverage has a Brix in the range of from about 4 to about 14. In some such embodiments, the beverage is a tea. In some embodiments, a total content of Reb A in the range of from about 5% to about 8% by weight. In some such embodiments, the beverage is milk.

In some embodiments, the beverage has a pH in the range of about 2.2 to about 7.5, e.g., about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, inclusive of all values and ranges therebetween. In some embodiments, the beverage has a pH ranging from about 6 to about 7. In some such embodiments, the beverage is milk. In some embodiments, the beverage has a pH ranging from about 2.5 to about 3.5. In some such embodiments, the beverage is an energy drink or a sports drink. In some embodiments, the beverage has a pH ranging from about 2.5 to about 5. In some such embodiments, the beverage is a fruit juice. In some embodiments, the beverage has a pH ranging from about 2.5 to about 3.5. In some such embodiments, the beverage is a fruit drink. In some embodiments, the beverage has a pH ranging from about 2.5 to about 5.0. In some such embodiments, the beverage is a soda. In some such embodiments, the beverage is a fruit drink. In some embodiments, the beverage has a pH ranging from about 2.5 to about 5.0. In some such embodiments, the beverage is an energy drink. In some such embodiments, the beverage is a fruit drink. In some embodiments, the beverage has a pH ranging from about 2.8 to about 5.2. In some such embodiments, the beverage is a tea or coffee.

In some embodiments, the beverages disclosed herein comprise Reb A in an amount of about 1 ppm to about 2000 ppm, for example, about 1 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, including all the values and subranges that lie therebetween. In some embodiments, the beverages disclosed herein comprise Reb A in an amount of about 100 ppm to about 700 ppm, e.g., about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, and about 700 ppm, including all the values and subranges that lie therebetween.

In some embodiments, the beverages disclosed herein comprise one foam suppressing agent. In some embodiments, the beverages disclosed herein comprise at least two foam suppressing agents. In some embodiments, the beverages disclosed herein comprise at least three foam suppressing agents. In some embodiments, the beverages disclosed herein comprise at least four foam suppressing agents. In some embodiments, the beverages disclosed herein comprise one, two, three, four, five fix, seven, eight, nine or ten foam suppressing agents.

In some embodiments, the beverages disclosed herein comprise at least one foam suppressing agent in a concentration ranging from about 1 ppm to about 2000 ppm, for example, about 10 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, including all the values and subranges that lie therebetween. In some embodiments, the beverages disclosed herein comprise at least one foam suppressing agent in a concentration ranging from about 1 ppm to about 800 ppm. In some embodiments, the beverages disclosed herein comprise at least one foam suppressing agent in a concentration ranging from about 25 ppm to about 100 ppm, e.g., about 30, about 35, about 40, about 45, about 50, about 55, about 60, about 65, about 70, about 75, about 80, about 85, about 90, about 95, and about 100, including all values and subranges that lie therebetween.

In some embodiments, the at least one foam suppressing agent is present in the beverages disclosed herein in a concentration at which the foam suppressing agent does not significantly contribute to the sweetness of the beverage. In alternative embodiments, the at least one foam suppressing agent is present in the beverages disclosed herein in a concentration at which the foam suppressing agent contributes to the sweetness profile of the beverage. In some embodiments, the at least one foam suppressing agent independently provides a Brix in the range of about 0 to about 2 in terms of sucrose, e.g., about 0, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, and about 2.0 Brix.

In some embodiments, the weight percent (% wt) of the at least one foam suppressing agent in the present beverages is the range of from about 0.001% wt to about 10% wt, e.g., about 0.001% wt, about 0.002% wt, about 0.003% wt, about 0.004% wt, about 0.005% wt, about 0.006% wt, about 0.007% wt, about 0.008% wt, about 0.009% wt, about 0.01% wt, about 0.02% wt, about 0.03% wt, about 0.04% wt, about 0.05% wt, about 0.06% wt, about 0.07% wt, about 0.08% wt, about 0.09% wt, about 0.1% wt, about 0.2% wt, about 0.3% wt, about 0.4% wt, about 0.5% wt, about 0.6% wt, about 0.7% wt, about 0.8% wt, about 0.9% wt, about 1% wt, about 2% wt, about 3% wt, about 4% wt, or about 5% wt, about 6% wt, about 7% wt, about 8% wt, about 9% wt, about 10% wt, inclusive of all values and subranges that lie therebetween.

In some embodiments, the beverages disclosed herein comprise at least one foam suppressing agent in an amount of about 0.0001% v/v to about 1% v/v, for example, an amount of about 0.0001% v/v, about 0.0005% v/v, about 0.001% v/v, about 0.005% v/v, about 0.01% v/v, about 0.05% v/v, about 0.1% v/v, about 0.5% v/v, about 1% v/v, including all values and subranges that lie therebetween. In some embodiments, the at least one foam suppressing agent is present in an amount of about 0.0001% v/v to about 0.1% v/v.

In some embodiments, the ratio of Reb A to the at least one foam suppressing agent ranges from about 1:99 to about 99:1, for example, about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, including all values and subranges that lie therebetween. In particular embodiments, the ratio of Reb A to the at least one foam suppressing agent is in the range of from about 10:1 to about 1:3, including about 10:1, about 3:1, about 1:1 or about 1:3. In some embodiments, the ratio of Reb A to the at least one foam suppressing agent ranges from about 50:1 to about 1:10, for example, about 50:1, about 45:1, about 40:1, about 35:1, about 30:1, about 25:1, about 20:1, about 15:1, about 10:1, about 5:1, about 4:1, about 3:1, about 2:1, about 1:1, about 1:2, about 1:3, about 1:4, about 1:5, about 1:6, about 1:7, about 1:8, about 1:9, or about 1:10, including all values and subranges that lie therebetween. In some embodiments, the ratio of Reb A to the at least one foam suppressing agent ranges from about 20:1 to about 1:5.

In some embodiments in which foam stability is reduced, Reb A is present in an excess relative to the one or more foam suppressing agents. Alternatively stated, in some embodiments, the ratio of Reb A to the at least one foam suppressing agent is greater than about 1:1, for example ranging from about 1.5:1 to about 20:1, including about 1.5:1, about 2:1, about 3:1, about 4:1, about 5:1, about 6:1 about 7:1, about 8:1, about 9:1, about 10:1, about 15:1 and about 20:1, inclusive of all values and ranges that lie therebetween. In some embodiments in which foam stability is reduced, the foam suppressing agent is present (e.g., in the beverage) in a concentration ranging from about 25 ppm to about 300 ppm, e.g., about 25 ppm, about 50 μm, about 75 ppm, about 100 ppm, about 125 ppm, about 150 ppm, about 175 ppm, about 200 ppm, about 225 ppm, about 250 ppm, about 275 ppm, and about 300 ppm, inclusive of all values and ranges that lie therebetween. In some embodiments in which foam stability is reduced, the foam suppressing agent is present (e.g., in the beverage) in a concentration ranging from about 25 ppm to less than 150 ppm. In some embodiments in which foam stability is reduced, the foam suppressing agent is present (e.g., in the beverage) in a concentration ranging from about 25 ppm to about 125 ppm. In some embodiments in which foam stability is reduced, the foam suppressing agent is present (e.g., in the throw syrup) in a concentration ranging from about 50 ppm to about 600 ppm, e.g., about 50 μm, about 75 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, and about 600 ppm, inclusive of all values and ranges that lie therebetween. In some embodiments in which foam stability is reduced, the foam suppressing agent is present (e.g., in the throw syrup) in a concentration ranging from about 100 ppm to less than 600 ppm, inclusive of all values and ranges that lie therebetween. In some embodiments in which foam stability is reduced, the foam suppressing agent is present (e.g., in the throw syrup) in a concentration ranging from about 100 ppm to about 550 ppm, inclusive of all values and ranges that lie therebetween.

In some embodiments, the beverages disclosed herein comprise Reb A and Reb E. In some embodiments, Reb E is present in a concentration ranging from about 1 ppm to about 2000 ppm, for example, about 10 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, including all the values and subranges that lie therebetween. In some embodiments, Reb E is present in a concentration ranging from about 1 ppm to about 800 ppm. In some embodiments, Reb E is present in a concentration ranging from about 25 ppm to about 100 ppm, e.g., about 30, about 35, about 40, about 45, about 50, about 55, about 60, about 65, about 70, about 75, about 80, about 85, about 90, about 95, and about 100, including all values and subranges that lie therebetween.

In some embodiments, the beverages disclosed herein comprise Reb E in an amount of about 0.0001% v/v to about 1% v/v, for example, an amount of about 0.0001% v/v, about 0.0005% v/v, about 0.001% v/v, about 0.005% v/v, about 0.01% v/v, about 0.05% v/v, about 0.1% v/v, about 0.5% v/v, and about 1% v/v, including all values and subranges that lie therebetween. In some embodiments, Reb E is present in an amount of about 0.0001% v/v to about 0.1% v/v.

In some embodiments, the ratio of Reb A to Reb E ranges from about 1:99 to about 99:1, for example, from about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, including all values and subranges that lie therebetween. In some embodiments, the ratio of Reb A to Reb E ranges from about 50:1 to about 1:10, for example, about 50:1, about 45:1, about 40:1, about 35:1, about 30:1, about 25:1, about 20:1, about 15:1, about 10:1, about 5:1, about 4:1, about 3:1, about 2:1, about 1:1, about 1:2, about 1:3, about 1:4, about 1:5, about 1:6, about 1:7, about 1:8, about 1:9, or about 1:10, including all values and subranges that lie therebetween. In some embodiments, Reb A and Reb E are present in a ratio of about 1:3; about 1:2, about 1:1, about 2:1 or about 3:1. In some embodiments, the ratio of Reb A to Reb E ranges from about 20:1 to about 1:5.

In some embodiments, the beverages disclosed herein comprise Reb A and Reb C. In some embodiments, Reb C is present in a concentration ranging from about 1 ppm to about 2000 ppm, for example, about 10 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, including all the values and subranges that lie therebetween. In some embodiments, Reb C is present in a concentration ranging from about 1 ppm to about 800 ppm. In some embodiments, Reb C is present in a concentration ranging from about 25 ppm to about 100 ppm, e.g., about 30, about 35, about 40, about 45, about 50, about 55, about 60, about 65, about 70, about 75, about 80, about 85, about 90, about 95, and about 100, including all values and subranges that lie therebetween.

In some embodiments, the beverages disclosed herein comprise Reb C in an amount of about 0.0001% v/v to about 1% v/v, for example, an amount of about 0.0001% v/v, about 0.0005% v/v, about 0.001% v/v, about 0.005% v/v, about 0.01% v/v, about 0.05% v/v, about 0.1% v/v, about 0.5% v/v, about 1% v/v, including all values and subranges that lie therebetween. In some embodiments, Reb C is present in an amount of about 0.0001% v/v to about 0.1% v/v.

In some embodiments, the ratio of Reb A to Reb C ranges from about 1:99 to about 99:1, for example, from about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, including all values and subranges that lie therebetween. In some embodiments, the ratio of Reb A to Reb C ranges from about 50:1 to about 1:10, for example, about 50:1, about 45:1, about 40:1, about 35:1, about 30:1, about 25:1, about 20:1, about 15:1, about 10:1, about 5:1, about 4:1, about 3:1, about 2:1, about 1:1, about 1:2, about 1:3, about 1:4, about 1:5, about 1:6, about 1:7, about 1:8, about 1:9, or about 1:10, including all values and subranges that lie therebetween. In some embodiments, Reb A and Reb C are present in a ratio of about 1:3; about 1:2, about 1:1, about 2:1 or about 3:1. In some embodiments, the ratio of Reb A to Reb C ranges from about 20:1 to about 1:5.

In some embodiments, the beverages disclosed herein comprise Reb A and stevioside. In some embodiments, stevioside is present in a concentration ranging from about 1 ppm to about 2000 ppm, for example, about 10 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, including all the values and subranges that lie therebetween. In some embodiments, stevioside is present in a concentration ranging from about 1 ppm to about 800 ppm. In some embodiments, stevioside is present in a concentration ranging from about 25 ppm to about 100 ppm, e.g., about 30, about 35, about 40, about 45, about 50, about 55, about 60, about 65, about 70, about 75, about 80, about 85, about 90, about 95, and about 100, including all values and subranges that lie therebetween.

In some embodiments, the beverages disclosed herein comprise stevioside in an amount of about 0.0001% v/v to about 1% v/v, for example, an amount of about 0.0001% v/v, about 0.0005% v/v, about 0.001% v/v, about 0.005% v/v, about 0.01% v/v, about 0.05% v/v, about 0.1% v/v, about 0.5% v/v, about 1% v/v, including all values and subranges that lie therebetween. In some embodiments, stevioside is present in an amount of about 0.0001% v/v to about 0.1% v/v.

In some embodiments, the ratio of Reb A to stevioside ranges from about 1:99 to about 99:1, for example, from about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, including all values and subranges that lie therebetween. In some embodiments, Reb A and stevioside are present in a ratio of about 1:3; about 1:2, about 1:1, about 2:1 or about 3:1. In some embodiments, the ratio of Reb A to stevioside ranges from about 50:1 to about 1:10, for example, about 50:1, about 45:1, about 40:1, about 35:1, about 30:1, about 25:1, about 20:1, about 15:1, about 10:1, about 5:1, about 4:1, about 3:1, about 2:1, about 1:1, about 1:2, about 1:3, about 1:4, about 1:5, about 1:6, about 1:7, about 1:8, about 1:9, or about 1:10, including all values and subranges that lie therebetween. In some embodiments, Reb A and stevioside are present in a ratio of about 1:3; about 1:2, about 1:1, about 2:1 or about 3:1. In some embodiments, the ratio of Reb A to stevioside ranges from about 20:1 to about 1:5.

In some embodiments, the beverages disclosed herein comprise RebA and rubusoside. In some embodiments, rubusoside is present in a concentration ranging from about 1 ppm to about 2000 ppm, for example, about 10 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, including all the values and subranges that lie therebetween. In some embodiments, rubusoside is present in a concentration ranging from about 1 ppm to about 800 ppm. In some embodiments, rubusoside is present in a concentration ranging from about 25 ppm to about 100 ppm, e.g., about 30, about 35, about 40, about 45, about 50, about 55, about 60, about 65, about 70, about 75, about 80, about 85, about 90, about 95, and about 100, including all values and subranges that lie therebetween.

In some embodiments, the beverages disclosed herein comprise rubusoside in an amount of about 0.0001% v/v to about 1% v/v, for example, an amount of about 0.0001% v/v, about 0.0005% v/v, about 0.001% v/v, about 0.005% v/v, about 0.01% v/v, about 0.05% v/v, about 0.1% v/v, about 0.5% v/v, about 1% v/v, including all values and subranges that lie therebetween. In some embodiments, rubusoside is present in an amount of about 0.0001% v/v to about 0.1% v/v.

In some embodiments, the ratio of Reb A to rubusoside ranges from about 1:99 to about 99:1, for example, from about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, including all values and subranges that lie therebetween. In some embodiments, Reb A and rubusoside are present in a ratio of about 1:3; about 1:2, about 1:1, about 2:1 or about 3:1. In some embodiments, the ratio of Reb A to rubusoside ranges from about 50:1 to about 1:10, for example, about 50:1, about 45:1, about 40:1, about 35:1, about 30:1, about 25:1, about 20:1, about 15:1, about 10:1, about 5:1, about 4:1, about 3:1, about 2:1, about 1:1, about 1:2, about 1:3, about 1:4, about 1:5, about 1:6, about 1:7, about 1:8, about 1:9, or about 1:10, including all values and subranges that lie therebetween. In some embodiments, Reb A and rubusoside are present in a ratio of about 1:3; about 1:2, about 1:1, about 2:1 or about 3:1. In some embodiments, the ratio of Reb A to rubusoside ranges from about 20:1 to about 1:5.

In some embodiments, the beverage is a carbonated beverage comprising Reb A, and at least one foam suppressing agent, wherein the at least one foam suppressing agent is Reb E, stevioside, rubusoside, Reb C, or any combination thereof, wherein the carbonated beverage has a foam height that is less than a foam height of a Reb A control carbonated beverage by about 1% to about 50%; a foam stability that is less than a foam stability of the Reb A control carbonated beverage by about 1% to about 70%; or a combination thereof, wherein Reb A is present in a concentration of about 100 ppm to about 700 ppm and wherein the at least one foam suppressing agent is present in a concentration of about 25 ppm to about 100 ppm.

### Throw Syrups Comprising Reb a and Foam Suppressing Agent

The disclosure further provides throw syrups comprising Reb A, and at least one foam suppressing agent, wherein the foam suppressing agent is Reb E, stevioside, rubusoside, Reb C, or any combination thereof. The throw syrups can be used to prepare any of the beverages described herein by adding an appropriate amount of water or other liquid medium. In some embodiments, the throw syrups disclosed herein comprise Reb A in a concentration of about 100 ppm to about 10,000 ppm, for example, about 200 ppm, about 500 ppm, about 1000 ppm, about 2000 ppm, about 3000 ppm, about 4000 ppm, about 5000 ppm, about 6000 ppm, about 7000 ppm, about 8000 ppm, about 9000 ppm, about 10,000 ppm, including all subranges and values that lie therebetween. In some embodiments, the throw syrups disclosed herein comprise Reb A in a concentration of about 500 ppm to about 7000 ppm, e.g., about 500 ppm, about 600 ppm, about 700 ppm, about 800 ppm, about 900 ppm, about 1000 ppm, about 2000 ppm, about 3000 ppm, about 4000 ppm, about 5000 ppm, about 6000 ppm, about 7000 ppm, including all subranges and values that lie therebetween.

In some embodiments, the throw syrups disclosed herein comprise least one foam suppressing agent comprising Reb E, stevioside, rubusoside, Reb C, or any combination thereof. In some embodiments, the at least one foam suppressing agent is present in a concentration of about 1 ppm to about 10,000 ppm, for example, about 50 ppm, about 100 ppm, about 200 ppm, about 500 ppm, about 1000 ppm, about 2000 ppm, about 3000 ppm, about 4000 ppm, about 5000 ppm, about 6000 ppm, about 7000 ppm, about 8000 ppm, about 9000 ppm, about 10,000 ppm, including all subranges and values that lie therebetween. In some embodiments, the throw syrups disclosed herein comprise least one foam suppressing agent in a concentration of about 5 ppm to about 8000 ppm. In some embodiments, the throw syrups disclosed herein comprise at least one foam suppressing agent in a concentration of about 125 ppm to about 1000 ppm, e.g., about 125 ppm, about 150 ppm, about 200 ppm, about 250 ppm, about 300 ppm, about 350 ppm, about 400 ppm, about 450 ppm, about 500 ppm, about 550 ppm, about 600 ppm, about 650 ppm, about 700 ppm, about 750 ppm, about 800 ppm, about 850 ppm, about 900 ppm, about 950 ppm, and about 1000 ppm, including all subranges and values that lie therebetween.

In some embodiments, the weight percent (% wt) of the at least one foam suppressing agent in throw syrup is the range of from about 0.001% wt to about 10% wt, e.g., about 0.001% wt, about 0.002% wt, about 0.003% wt, about 0.004% wt, about 0.005% wt, about 0.006% wt, about 0.007% wt, about 0.008% wt, about 0.009% wt, about 0.01% wt, about 0.02% wt, about 0.03% wt, about 0.04% wt, about 0.05% wt, about 0.06% wt, about 0.07% wt, about 0.08% wt, about 0.09% wt, about 0.1% wt, about 0.2% wt, about 0.3% wt, about 0.4% wt, about 0.5% wt, about 0.6% wt, about 0.7% wt, about 0.8% wt, about 0.9% wt, about 1% wt, about 2% wt, about 3% wt, about 4% wt, or about 5% wt, about 6% wt, about 7% wt, about 8% wt, about 9% wt, about 10% wt, inclusive of all values and subranges that lie therebetween.

In some embodiments, the throw syrups disclosed herein comprise one foam suppressing agent. In some embodiments, the throw syrups disclosed herein comprise at least two foam suppressing agents. In some embodiments, the throw syrups disclosed herein comprise at least three foam suppressing agents. In some embodiments, the throw syrups disclosed herein comprise at least four foam suppressing agents. In some embodiments, the throw syrups disclosed herein comprise one, two, three, four, five fix, seven, eight, nine or ten foam suppressing agents.

In some embodiments, when any one of the throw syrups disclosed herein is added to a liquid medium to form a beverage, the beverage has a foam height that is less than a foam height of a Reb A control beverage by at least about 1% (e.g. by about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, including all values and subranges that lie therebetween). In some embodiments, when any one of the throw syrups disclosed herein is added to a liquid medium to form a beverage, the beverage has a foam stability that is less than a foam stability of the Reb A control beverage by at least about 1% e.g. by about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, including all values and subranges that lie therebetween). In some embodiments, when any one of the throw syrups disclosed herein is added to a liquid medium to form a beverage, the beverage has a foam height that is less than a foam height of a Reb A control beverage by at least about 1% e.g. by about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, including all values and subranges that lie therebetween) and a foam stability that is less than a foam stability of the RebA control beverage by at least about 1% e.g. by about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, including all values and subranges that lie therebetween). In some embodiments, the beverage prepared from the throw syrup disclosed has a foam height that is less than a foam height of a Reb A control beverage by about 1% to about 50% (e.g. by about 1%, about 5%, about 10%, about 15%, about 20%, about 25%, about 30%, about 35%, about 40%, about 45%, about 50%, inclusive of all values and subranges therebetween). In some embodiments, the beverage prepared from the throw syrup disclosed herein has a foam stability that is less than a foam stability of the Reb A control beverage by about 1% to about 70% % (e.g. by about 1%, about 5%, about 10%, about 15%, about 20%, about 25%, about 30%, about 35%, about 40%, about 45%, about 50%, about 55%, about 60%, about 65%, and about 70%, inclusive of all values and subranges therebetween).

In some embodiments, the beverage prepared from the throw syrups disclosed herein is a carbonated beverage. The resulting carbonated beverage may have any amount of CO₂ disclosed herein.

In some embodiments, the beverage prepared from the throw syrups disclosed herein has a pH in the range of about 2.2 to about 7.5, e.g., about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, and 7.0, about 7.1, about 7.2, about 7.3, about 7.4, and about 7.5, inclusive of all values and ranges therebetween.

some embodiments, the beverage prepared from the throw syrups disclosed herein has a Brix in the range of from about 0.5 to about 14 in terms of sucrose; for example, a Brix of about 1, about 1.5, about 2, about 2.5, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5 or about 14, in terms of sucrose, inclusive of all values and subranges that lie therebetween.

In some embodiments, the throw syrup is added to a liquid medium to form a beverage. The ratio of liquid medium to the throw syrup may be in the range of from about 2:1 to about 12:1, including about 2:1, about 3:1, about 4:1, about 5:1, about 6:1, about 7:1, about 8:1, about 9:1 about 10:1, about 11:1, and about 12:1, inclusive of all values and subranges therebetween. In particular embodiments, the ratio of liquid medium to the throw syrup is about 5:1. In some such embodiments, the throw syrup is a soda syrup, and the beverage is a soda. In particular embodiments, the ratio of liquid medium to the throw syrup is about 9:1. In some such embodiments, the throw syrup is a chocolate syrup and the beverage is chocolate milk or other chocolate flavored beverage.

### Additives to Beverages and Throw Syrups

In some embodiments, the beverages and throw syrups disclosed herein may include a juice-based composition obtained from fruit or vegetable. The juice-based composition can be used in any form such as a juice form, a concentrate, an extract, a powder (which can be reconstituted with water or other suitable liquids), or the like. Suitable juices include, for example, non-citrus juices such as apple juice, grape juice, pear juice, nectarine juice, currant juice, raspberry juice, gooseberry juice, blackberry juice, blueberry juice, strawberry juice, custard-apple juice, pomegranate juice, guava juice, kiwi juice, mango juice, papaya juice, watermelon juice, cantaloupe juice, cherry juice, cranberry juice, peach juice, apricot juice, plum juice, and pineapple juice; citrus juices such as orange juice, lemon juice, lime juice, grapefruit juice, and tangerine juice; and vegetable juice such as carrot juice and tomato juice; or any combination thereof. The beverages and throw syrups disclosed herein may comprise fruit or vegetable liquids containing a percentage of solids derived from the fruit or vegetable, for example pulp, seeds, skins, fibers, and the like, and pectin, which is naturally occurring in the fruit or vegetable. In some embodiments, the juice-based composition is fortified with solubilized calcium in the form of calcium carbonate, calcium lactate, calcium oxide, or calcium hydroxide.

In some embodiments, the beverages and throw syrups disclosed herein comprise a dairy composition, wherein the dairy composition contains a dairy protein. Exemplary dairy compositions include any type of dairy product including cream, whole milk, reduced fat milk, skim milk, milk solids, condensed milk, or any combination thereof, specifically a combination of cream and skim milk. The dairy composition generally comprises an amount of dairy protein, for example whey protein containing beta-lactoglobulin, alpha-lactalbumin, or serum albumin; and the like. In some embodiments, the dairy product may be replaced with an amount of a non-dairy component such as soy milk, soy protein, almond milk, coconut milk, or any combination thereof.

In some embodiments, the beverages and throw syrups disclosed herein comprise a hydrocolloid composition. The hydrocolloid composition may contain a natural gum, a synthetic gum, a starch, a modified starch, pectin, gelatin, an alginate, a modified alkylcellulose, or any combination thereof. Specifically, the hydrocolloid composition may include propylene glycol alginate, gum arabic, pectin, locust bean gum, guar gum, gellan gum, xanthan gum, gum ghatti, modified gum ghatti, tragacanth gum, carrageenan, pregelatinized starch, pregelatinized high amylase-content starch, pregelatinized hydrolyzed starches, pregelatinized octenyl succinate substituted starch, a carboxymethylcellulose, or any combination thereof. In some embodiments, the beverages and throw syrups disclosed herein comprise a combination of propylene glycol alginate, gum arabic, and pectin.

In some embodiments, the beverages and throw syrups disclosed herein may further comprise a foam stabilizer, such as, for example, yucca schidigera extracts, quillaia extracts, Labiatae herb extracts, camosic acid, esters of camosic acid (including methyl camosate and ethyl camosate), camosol, rosmariquinone, rosmanol, epirosmanol, isorosmanol, rosmaridiphenol, 12-methoxycarnosic acid, Sophorajaponica saponin, enzyme-treated lecithins, enzyme-digested lecithins, plant sterols, plant lecithins, sphingolipids, soybean saponin, bile powder, animal sterols, tomato glucolipids, fractionated lecithins, barley husk extract, enzyme-treated soybean saponin extract, tea seed saponin, beet saponin, propylene glycol fatty acid esters, sarsaparilla extracts, sorbitan fatty acid esters, sucrose fatty acid esters, and mixtures thereof. In some embodiments, the foam stabilizer comprises yucca schidigera extracts, quillaia extracts, or a mixture thereof. In some embodiments, the foam stabilizer consists of yucca schidigera extract and quillaia extract.

In some embodiments, the beverages and throw syrups disclosed herein may further comprise an alcohol composition. Examples of suitable alcohol compositions include, hop/malt/grain-based alcohol composition such as ale, lager, shandy, beer, including low alcohol beers (“near beer”), etc.; cider, spirit, liqueur, wine, or any combination thereof. In some embodiments, the beverages and throw syrups disclosed herein may comprise a suitable amount of a non-alcoholic hop/malt/grain-based composition.

In some embodiments, the beverages disclosed herein contain a dissolved gas under pressure such as carbon dioxide, nitrogen, oxygen, or nitrous oxide. In some embodiments, the dissolved gas is a mixture of nitrous oxide and carbon dioxide in a volume/volume ratio of about 1:99 to about 99:1, for example, from about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, including all values and subranges that lie therebetween. In some embodiments, the beverages may contain about 0.1 to about 5.0 volumes, for example, about 0.1 volume, about 0.5 volume, about 1 volume, about 1.5 volumes, about 2 volumes, about 2.5 volumes, about 3 volumes, about 3.5 volumes, about 4 volumes, about 4.5 volumes, including all values and subranges that lie therebetween.

In some embodiments, the beverages disclosed herein are carbonated beverages. The content of carbon dioxide gas in the carbonated beverage may be defined by gas pressure. For the carbon dioxide gas in the carbonated beverages disclosed herein, the gas pressure may be, for example, about 1.7 kgf/cm 2 or more, about 1.89 kgf/cm 2 or more, or about 2.15 kgf/cm 2 or more. The upper limit of the gas pressure may be, for example, 5.0 kgf/cm 2 or less or 4.0 kgf/cm 2 or less, as required. In some embodiments, the beverages disclosed herein may contain about 0.1 to about 5.0 volumes of carbon dioxide to volume of the beverage, for example, about 0.1 volume, about 0.2 volume, about 0.3 volume, about 0.4 volume, about 0.5 volume, about 0.6 volume, about 0.7 volume, about 0.8 volume, about 0.9 volume, 1 volume, about 1.1 volume, about 1.2 volume, about 1.3 volume, about 1.4 volume, 1.5 volumes, about 1.6 volume, about 1.7 volume, about 1.8 volume, about 1.9 volume, 2 volumes, about 2.1 volume, about 2.2 volume, about 2.3 volume, about 2.4 volume, 2.5 volumes, about 2.6 volume, about 2.7 volume, about 2.8 volume, about 2.9 volume, 3 volumes, about 3.1 volume, about 3.2 volume, about 3.3 volume, about 3.4 volume, 3.5 volumes, about 3.6 volume, about 3.7 volume, about 3.8 volume, about 3.9 volume, 4 volumes, about 4.1 volume, about 4.2 volume, about 4.3 volume, about 4.4 volume, 4.5 volumes, about 4.6 volume, about 4.7 volume, about 4.8 volume, about 4.9 volume, or 5 volumes, including all values and subranges that lie therebetween, of carbon dioxide per volume of the beverage composition. For instance, beverages such as colas, lemonades, ginger ales, and tonic waters may contain about 3.0 volumes to about 4.0 volumes of carbon dioxide to the volume of the beverage. As another example, fruit flavors and cream sodas may contain about 2.5 volumes to about 2.8 volumes of carbon dioxide to the volume of the beverage; and sparkling mineral water gas may contain less than about 2.0 volumes of carbon dioxide to the volume of the beverage. Gas volume can be calculated from grams of CO₂ using the following equation: CO₂ (g)=Gas volume*container size in liters*1.977 g/L, wherein 1.977 g/L is the density of CO₂ at 0° C.).

In some embodiments, the dissolved gas may be added to the finished beverage composition, which contains all of the desired beverage components. In other embodiments, the dissolved gas is added to a desired volume of water or other suitable liquid to form a water/suitable liquid containing dissolved gas, such as, for example, seltzer water. The water/suitable liquid containing dissolved gas can then be combined with the throw syrups disclosed herein to produce the finished beverage composition. In some embodiments, a dissolved gas, specifically carbon dioxide, can be added at the point of consumption. For example, in a restaurant or convenience store, a fountain beverage consisting of any one of the throw syrups disclosed herein and a source of carbonation are prepared for imminent consumer consumption.

The beverages disclosed herein may be full-calorie, mid-calorie, low-calorie and zero-calorie carbonated beverages. The carbonated beverages of this disclosure may be customized to provide the desired calorie content. For example, the carbonated beverages can be “full-calorie”, such that they have about 120 calories per 8 oz serving. Alternatively, carbonated beverages can be “mid-calorie”, such that they have less than about 60 calories per 8 oz serving. In other embodiments, the carbonated beverages can be “low-calorie”, such that they have less than 40 calories per 8 oz serving. In still other embodiments, the carbonated beverages can be “zero-calorie”, such that they have less than 5 calories per 8 oz. serving.

The beverages or throw syrups disclosed herein may further include additives including, but are not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, weighing agents, juice, dairy, cereal and other plant extracts, flavonoids, alcohols, polymers and combinations thereof.

In some embodiments, the beverages or throw syrup disclosed herein contain one or more polyols. The term “polyol”, as used herein, refers to a molecule that contains more than one hydroxyl group. Non-limiting examples of polyols include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols.

Suitable amino acid additives include, but are not limited to, aspartic acid, arginine, glycine, glutamic acid, praline, threonine, theanine, cysteine, cystine, alanine, valine, tyrosine, leucine, arabinose, trans-4-hydroxyproline, isoleucine, asparagine, serine, lysine, histidine, omithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). As used herein, amino acids also encompass both peptides and polypeptides (e.g., di peptides, tripeptides, tetrapeptides, and pentapeptides) such as glutathione and L-alanyl-L-glutamine.

Suitable polyamino acid additives include poly-L-aspartic acid, poly-L-lysine (e.g., poly-L-α-lysine or poly-L-ε-lysine), poly-L-omithine (e.g., poly-L-α-omithine or poly-L-ε-ornithine), poly-L-arginine, other polymeric forms of amino acids, and salt forms thereof (e.g., calcium, potassium, sodium, or magnesium salts such as L-glutamic acid mono sodium salt). Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof. Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable bitter compound additives include, but are not limited to, quinine, urea, bitter orange oil, naringin, quassia, caffeine, and salts thereof. Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™) gum acacia seyal, carageenan), poly-L-lysine (e.g., poly-L-α-lysine or poly-L-ε-lysine), poly-L-omithine (e.g., poly-L-α-omithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui North Co., Ltd., Japan), polyphenols, rutins (e.g., enzyme modified rutin Sanmelin™ AO (San-fl Gen F.F.I., Inc., Osaka, Japan)), neohesperidin, naringin, neohesperidin dihydrochalcone, and the like. Suitable astringent compound additives include, but are not limited to, tannic acid, europium chloride (EuCl3), gadolinium chloride (GdCl3), terbium chloride (TbCl3), alum, tannic acid, and polyphenols (e.g., tea polyphenols).

The beverages and throw syrups disclosed herein may further comprise components approved as food additives, or other components, such as, flavoring agents, acidulants, perfumes, and other flavors. In some embodiments, the beverages and throw syrups disclosed herein may comprise flavoring agents such as natural flavors, artificial flavors, spices, seasonings, and the like. Exemplary flavoring agents include synthetic flavor oils and flavoring aromatics and/or oils, oleoresins, essences, distillates, and extracts derived from plants, leaves, flowers, fruits, or any combination thereof.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, cherry, raspberry, blackberry, tropical fruit, mango, mangosteen, pomegranate, papaya and so forth. Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a root beer flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bay leaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, the beverages and throw syrups disclosed herein may include other flavoring agents such as, aldehydes and esters, for example, cinnamyl acetate, cinnamaldehyde, citral diethylacetal, dihydrocarvyl acetate, eugenyl formate, p-methylamisol, and so forth can be used. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal, decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Any flavoring or food additive such as those described in Chemicals Used in Food Processing, publication 1274, pages 63-258, by the National Academy of Sciences, may be used. This publication is incorporated herein by reference in its entirety.

In some embodiments, the flavorant is present in the beverages disclosed herein in a concentration range of about 0.1 ppm to about 4000 ppm, for example, about 0.5 ppm, about 1 ppm, about 5 ppm, about 10 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm or about 2000 ppm, about 2500 ppm, about 3000 ppm, about 3500 ppm, or about 4000 ppm, including all values and subranges that lie therebetween.

The flavoring agent may additionally contain weighting agents, emulsifiers, emulsion stabilizers, antioxidants, liquid vehicles, and the like. Weighting agents can include, but are not limited to brominated vegetable oil, ester gums, SAIB (sucrose acetate isobutyrate) or any combination thereof. The beverages and throw syrups disclosed herein may also contain, in addition to a flavoring agent, a flavor potentiator. Flavor potentiators are materials that can intensify, supplement, modify or enhance the taste and/or aroma perception of a composition without introducing a characteristic taste and/or aroma perception of their own. In some embodiments, potentiators designed to intensity, supplement, modify, or enhance the perception of flavor, sweetness, tartness, umami, kokumi, saltiness, or any combination thereof. In some embodiments, examples of suitable potentiators, also known as taste potentiators include neohesperidin, dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxy ethyl)-6-(hydroxymethyppyridinium-3-ol inner salt), sugar beet extract (alcoholic extract), sugarcane leaf essence (alcoholic extract), curculin, strogin, mabinlin, gynmemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs), G-protein coupled receptors (T2Rs and T1Rs), and taste potentiator compositions that impart kokumi, as disclosed in U.S. Pat. No. 5,679,397 to Kuroda et al., which is incorporated in its entirety herein by reference, or any combination thereof.

In some embodiments, the beverages and throw syrups disclosed herein may comprise additives such as coloring agents (“colorants”, “colorings”), food-grade acids, micronutrients, plant extracts, phytochemicals (“phytonutrients”), preservatives, salts including buffering salts, stabilizers, medicaments, or any combination thereof. In some embodiments, the beverages and throw syrups disclosed herein comprise a salt. Suitable salts include, for example, alkali or alkaline earth metal chlorides, glutamates, and the like. For example, monosodium glutamate, potassium chloride, sodium chloride, or any combination thereof. In some embodiments, the beverages and throw syrups disclosed herein comprise a food grade acid. Suitable food-grade acids for use in the composition include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, or any combination thereof. The food-grade acid can be added as acidulant to control the pH of the beverage and also to provide some preservative properties, or to stabilize the beverage.

Exemplary phytochemicals include lutein, lycopene, carotene, anthocyanin, capsaicinoids, flavonoids, hydroxycinnamic acids, isoflavones, isothiocyanates, monoterpenes, chalcones, coumestans, dihydroflavonols, flavanoids, flavanols, quercetin, flavanones, flavones, flavan-3-ols (catechins, epicatechin, epigallocatechin, epigallocatechingallate, and the like), flavonals (anthocyanins, cyanidine, and the like); phenolic acids; phytosterols, saponins, terpenes (carotenoids), or any combination thereof. Suitable plant extracts which contain one or more phytochemicals include fruit skin extracts (grape, apple, crab apple, and the like), green tea extracts, white tea extracts, green coffee extract, or any combination thereof. Exemplary herbals include Echinacea, Goldenseal, Calendula, Rosemary, Thyme, Kava Kava, Aloe, Blood Root, Grapefruit Seed Extract, Black Cohosh, Ginseng, Guarana, Cranberry, Ginko Biloba, St. John's Wort, Evening Primrose Oil, Yohimbe Bark, Green Tea, Ma Huang, Maca, Bilberry, extracts thereof, or any combination thereof.

In some embodiments, the pH of the beverages disclosed herein may be modified by the addition of food-grade compounds such as ammonium hydroxide, sodium carbonate, potassium carbonate, sodium bicarbonate, and the like, or any combination thereof. Additionally, the pH of the beverage can be adjusted by the addition of carbon dioxide. Further, in some embodiments, buffering agents including, but not limited to citrates such as sodium citrate, can be used to adjust the pH of the beverage.

Coloring agents can be used in amounts effective to produce a desired color for the composition. The colorants may include pigments, natural food colors and dyes suitable for food, drug and cosmetic applications. A full recitation of all F.D.& C. colorants and their corresponding chemical structures can be found in the Kirk-Othmer Encyclopedia of Chemical Technology, 3rd Edition, in volume 5 at pages 857-884, of which text is incorporated herein by reference. As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), or any combination thereof.

Exemplary coloring agents include, but are not limited to, annatto extract, (E160b), bixin, norbixin, astaxanthin, dehydrated beets (beet powder), beetroot red/betanin (E162), ultramarine blue, caramel color (E150a), canthaxanthin (E161g), cryptoxanthin (E161c), rubixanthin (E161d), violanxanthin (E161e), rhodoxanthin (E161f), caramel (E150(a-d)), β-apo-8′-carotenal (El 60e), β-carotene (El 60a), alpha carotene, gamma carotene, ethyl ester of beta-apo-8 carotenal (E1600, flavoxanthin (El 61a), lutein (El 61b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (El 63), haematococcus algae meal, synthetic iron oxide, iron oxides and hydroxides (El 72), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (El 00), turmeric oleoresin, amaranth (E123), capsanthin/capsorbin (El 60c), lycopene (El 60d), or any combination thereof.

Exemplary certified colors include, but are not limited to, FD&C blue #1, FD&C blue #2, FD&C green #3, FD&C red #3, FD&C red #40, FD&C yellow #5 and FD&C yellow #6, tartrazine (El 02), quinoline yellow (El 04), sunset yellow (E110), ponceau (E124), erythrosine (E127), patent blue V (E131), titanium dioxide (El 71), aluminium (El 73), silver (El 74), gold (El 75), pigment rubine/lithol rubine BK (El 80), calcium carbonate (El 70), carbon black (El 53), black PN/brilliant black BN (E151), green S/acid brilliant green BS (E142), or any combination thereof. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

In some embodiments, the beverages and throw syrups disclosed herein comprise emulsifiers, such as, for example, lecithin (e.g., soy lecithin); mono and di-glycerides of long chain fatty acids, specifically saturated fatty acids, and more specifically, stearic and palmitic acid mono- and diglycerides; mono and di-glycerides of acetic acid, citric acid, tartaric acid, or lactic acid; egg yolks; polysorbates (e.g., polysorbate 20, polysorbate 40, polysorbate 60, polysorbate 65, and polysorbate 80),propylene glycol esters (e.g., propylene glycol monostearate); propylene glycol esters of fatty acids; sorbitan esters (e.g., sorbitan monostearates, sorbitan tristearates, sorbitan monolaurate, sorbitan monooleate), sucrose monoesters; polyglycerol esters; polyethoxylated glycerols; and the like, or any combination thereof.

In some embodiments, the beverages and throw syrups disclosed herein comprise preservatives, such as, antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, ozone, or any combination thereof. Other examples of suitable preservatives include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, or any combination thereof.

The beverages and throw syrups disclosed herein can further contain one or more functional ingredients, which provide a real or perceived heath benefit to the composition. Functional ingredients include, but are not limited to, saponins, antioxidants, dietary fiber sources, fatty acids, vitamins, glucosamine, minerals, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. Saponins are glycosidic natural plant products comprising an aglycone ring structure and one or more sugar moieties. The combination of the nonpolar aglycone and the water soluble sugar moiety gives saponins surfactant properties, which allow them to form a foam when shaken in an aqueous solution. Several common sources of saponins include soybeans, which have approximately 5% saponin content by dry weight, soapwort plants (Saponaria), the root of which was used historically as soap, as well as alfalfa, aloe, asparagus, grapes, chickpeas, yucca, and various other beans and weeds.

In certain embodiments, the functional ingredient is at least one antioxidant. As used herein “antioxidant” refers to any substance which inhibits, suppresses, or reduces oxidative damage to cells and biomolecules. As such, antioxidants may prevent or postpone the onset of some degenerative diseases. Examples of antioxidants include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavanols (e.g., anthocyanidins), gallocatechins, epicatechin and its gallate forms, epigallocatechin and its gallate forms (ECGC) theaflavin and its gallate forms, thearubigins, isoflavone phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other antioxidants include, but are not limited to, fruits, vegetables, tea, cocoa, chocolate, spices, herbs, rice, organ meats from livestock, yeast, whole grains, or cereal grains. Suitable polyphenols include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In particular embodiments, the antioxidant is a catechin such as, for example, epigallocatechin gallate (EGCG). Suitable sources of catechins for embodiments of this invention include, but are not limited to, green tea, white tea, black tea, oolong tea, chocolate, cocoa, red wine, grape seed, red grape skin, purple grape skin, red grape juice, purple grape juice, berries, pycnogenol, and red apple peel. In some embodiments, the antioxidant is chosen from proanthocyanidins, procyanidins or combinations thereof. Suitable sources of proanthocyanidins and procyanidins for embodiments of this invention include, but are not limited to, red grapes, purple grapes, cocoa, chocolate, grape seeds, red wine, cacao beans, cranberry, apple peel, plum, blueberry, black currants, choke berry, green tea, sorghum, cinnamon, barley, red kidney bean, pinto bean, hops, almonds, hazelnuts, pecans, pistachio, pycnogenol, and colorful berries. In particular embodiments, the antioxidant is an anthocyanin. Suitable sources of anthocyanins for embodiments of this invention include, but are not limited to, red berries, blueberries, bilberry, cranberry, raspberry, cherry, pomegranate, strawberry, elderberry, choke berry, red grape skin, purple grape skin, grape seed, red wine, black currant, red currant, cocoa, plum, apple peel, peach, red pear, red cabbage, red onion, red orange, and blackberries.

In some embodiments, the antioxidant is chosen from quercetin, rutin or combinations thereof. Suitable sources of quercetin and rutin for embodiments of this invention include, but are not limited to, red apples, onions, kale, bog whortleberry, lingonberrys, chokeberry, cranberry, blackberry, blueberry, strawberry, raspberry, black currant, green tea, black tea, plum, apricot, parsley, leek, broccoli, chili pepper, berry wine, and ginkgo. In some embodiments, the antioxidant is resveratrol. Suitable sources of resveratrol for embodiments of this invention include, but are not limited to, red grapes, peanuts, cranberry, blueberry, bilberry, mulberry, Japanese Itadori tea, and red wine. In particular embodiments, the antioxidant is an isoflavone. Suitable sources of isoflavones for embodiments of this invention include, but are not limited to, soy beans, soy products, legumes, alfalfa sprouts, chickpeas, peanuts, and red clover.

In some embodiments, the antioxidant is curcumin. Suitable sources of curcumin for embodiments of this invention include, but are not limited to, turmeric and mustard. In particular embodiments, the antioxidant is chosen from punicalagin, ellagitannin or combinations thereof. Suitable sources of punicalagin and ellagitannin for embodiments of this invention include, but are not limited to, pomegranate, raspberry, strawberry, walnut, and oak-aged red wine. In some embodiments, the antioxidant is a citrus flavonoid, such as hesperidin or naringin. Suitable sources of citrus flavonids, such as hesperidin or naringin, for embodiments of this invention include, but are not limited to, oranges, grapefruits, and citrus juices. In particular embodiments, the antioxidant is chlorogenic acid. Suitable sources of chlorogenic acid for embodiments of this invention include, but are not limited to, green coffee, verba mate, red wine, grape seed, red grape skin, purple grape skin, red grape juice, purple grape juice, apple juice, cranberry, pomegranate, blueberry, strawberry, sunflower, Echinacea, pycnogenol, and apple peel.

In certain embodiments, the functional ingredient is at least one dietary fiber source. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, 0-glucans, pectins, gums, mucilage, waxes, inulins, oligosaccharides, fructooligosaccharides, cyclodextrins, chitins, and combinations thereof.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, Md.), OmegaPure (from Omega Protein, Houston, Tex.), Marinol C-38 (from Lipid Nutrition, Channahon, Ill.), Bonito oil and MEG-3 (from Ocean Nutrition, Dartmouth, NS), Evogel (from Symrise, Holzminden, Germany), Marine Oil, from tuna or salmon (from Arista Wilton, Conn.), OmegaSource 2000, Marine Oil, from menhaden and Marine Oil, from cod (from OmegaSource, RTP, NC). Suitable omega-6 fatty acids include, but are not limited to, linoleic acid, ganima-linolenic acid, dihommo-gamma-linolenic acid, arachidonic acid, eicosadienoic acid, docosadienoic acid, adrenic acid, docosapentaenoic acid and combinations thereof.

In some embodiments, the functional ingredient is chosen from at least one probiotic, prebiotic and combination thereof. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. Non-limiting examples of species of Lactobacilli found in the human intestinal tract include L. acidophilus, L. casei, L. fermentum, L. saliva roes, L. brevis, L. leichmannii, L. plantarum, L. cellobiosus, L. reuteri, L. rhamnosus, L. GG, L. bulgaricus, and L. thermophilus. Non limiting examples of prebiotics include, mucopolysaccharides, oligosaccharides, polysaccharides, amino acids, vitamins, nutrient precursors, proteins and combinations thereof.

The beverages and throw syrups disclosed herein may comprise herbs, minerals, micronutrients and vitamins that are believed to impart the drinker a boost in energy and an overall enhanced feeling of well-being. The herbs in the composition may include any one or more of Ginkgo biloba, guarana, and ginseng. Suitable vitamins or vitamin precursors include ascorbic acid (Vitamin C), beta carotene, niacin (Vitamin B3), riboflavin (Vitamin B2), thiamin (Vitamin B1), niacinamide, folate or folic acid, alpha tocopherols or esters thereof, Vitamin D, retinyl acetate, retinyl palmitate, pyridoxine (Vitamin B6), folic acid (Vitamin B9), cyanocobalimin (Vitamin B12), pantothenic acid, biotin, vitamin A, vitamin E, vitamin K, or a combination thereof.

Exemplary minerals include sodium, magnesium, chromium, iodine, iron, manganese, calcium, copper, fluoride, potassium, phosphorous, molybdenum, selenium, zinc, or any combination thereof. The minerals can be provided as a mineral salt, including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals. In some embodiments exemplary micronutrients can include L-camitine, choline, coenzyme Q10, alpha-lipoic acid, omega-3-fatty acids, pepsin, phytase, trypsin, lipases, proteases, cellulases, or any combination thereof.

The beverages and throw syrups disclosed herein may comprise any additive or ingredient listed or described in U.S. Pat. No. 9,169,285 and published U.S. application Ser. No. 12/563,261, each of which are incorporated herein by reference in their entireties.

### Sweetener Additives

In some embodiments, the beverages and throw syrups disclosed herein may comprise at least one additional sweetener that is generally used in beverages. In some embodiments, the beverages and throw syrups disclosed herein may further comprise sucrose. In some embodiments, the at least one additional sweetener may be a natural sweetener, a non-natural sweetener, a high potency sweetener, a carbohydrate sweetener, a synthetic sweetener or any combination thereof. In some embodiments, the additional sweetener is chosen from natural sweeteners other than Stevia sweeteners. In another embodiment, the at least one additional sweetener is chosen from synthetic high potency sweeteners. As used herein, the phrase “synthetic sweetener” refers to any composition which is not found naturally in nature and characteristically has a sweetness potency greater than sucrose, fructose, or glucose, yet has less calories.

In some embodiments, the at least one additional sweetener is a carbohydrate sweetener. Non-limiting examples of suitable carbohydrate sweeteners include sucrose, fructose, glucose, erythritol, maltitol, lactitol, sorbitol, mannitol, xylitol, tagatose, trehalose, galactose, rharnnose, cyclodextrin (e.g., alpha-cyclodextrin, beta-cyclodextrin, and gamma-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhanmose, ribose, isomerized liquid sugars such as high fructose corn/starch syrup (HFCS/HFSS) (e.g., HFCS55, HFCS42, or HFCS90), coupling sugars, soybean oligosaccharides, glucose syrup and combinations thereof. D- or L-configurations can be used when applicable.

Non-limiting examples of synthetic high potency sweeteners suitable for embodiments of this disclosure include sucralose, potassium acesulfame, acesulfame, acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

Suitable natural high potency sweeteners include, but are not limited to, rebaudioside B (Reb B), rebaudioside D (Reb D), rebaudioside F (Reb F), rebaudioside I (Reb I), rebaudioside H (Reb H), rebaudioside L (Reb L), rebaudioside K (Reb K), rebaudioside J (Reb J), rebaudioside N (Reb N), rebaudioside M (Reb M), rebaudioside O (Reb O), dulcosideA, dulcoside B, stevia, mogroside IV, mogroside V, Luo Han Guo, siamenoside, monatin and its salts (monatin SS, RR, RS, SR), curculin, glycyrrhizic acid and its salts, thaumatin, monellin, mabinlin, brazzein, hemandulcin, phyllodulcin, glycyphylin, phloridzin, trilobtain, baiyunoside, osladin, polypodoside A, pterocaryosideA, pterocaryoside B, mukurozioside, phlomisoside I, periandrin I, abrusoside A, steviolbioside and cyclocarioside I. The natural high potency sweetener may be provided as a pure compound or, alternatively, as part of an extract. For example, rebaudioside B may be provided as a sole compound or as part of a Stevia extract.

In some embodiments, the additional sweetener can be chemically or enzymatically modified natural high potency sweetener. Modified natural high potency sweeteners include glycosylated natural high potency sweetener such as glucosyl-, galactosyl-, fructosyl-derivatives containing 1-50 glycosidic residues. Glycosylated natural high potency sweeteners may be prepared by enzymatic transglycosylation reaction catalyzed by various enzymes possessing transglycosylating activity.

The at least one additional sweetener may be present in the beverages and throw syrups disclosed herein in an amount effective to provide a concentration from about 0.3 ppm to about 3,500 ppm, for example, about 1 ppm, about 50 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, about 1600 ppm, about 1700 ppm, about 1800 ppm, about 1900 ppm, about 2000 ppm, about 2500 ppm, about 300 ppm, or about 3500 ppm, including all the values and subranges that lie therebetween.

In some embodiments, the beverages and throw syrups disclosed herein are subject to homogenization conditions, such as high pressure homogenization, to provide a homogenous beverage composition. Any conventional homogenization equipment can be employed, such as equipment available from APV Gaulin, Alfa-Laval or Niro Soavi. In some embodiments, the beverage compositions disclosed herein are pasteurized to sterilize the product by destroying unwanted microorganisms. Exemplary processes to destroy or remove unwanted microorganisms include hot-filling, aseptic packaging, ozonation, radiation (e.g., ultraviolet light or gamma rays), membrane permeation, pulsed electric field, sonication, and the like.

Subject matter contemplated by the present disclosure is set out in the following numbered embodiments:

1. A beverage comprising Reb A and at least one foam suppressing agent comprising Reb E, stevioside, rubusoside, Reb C, or any combination thereof, wherein the beverage has one or more of the following characteristics:
(i) a foam height that is less than a foam height of a RebA control beverage by at least about 1%, and
(ii) a foam stability that is less than a foam stability of the RebA control beverage by at least about 1%.

2. The beverage of embodiment 1, wherein the beverage has a foam height that is less than a foam height of a RebA control beverage by at least about 1%.

3. The beverage of embodiment 1 or 2, wherein the beverage has a foam stability that is less than a foam stability of the RebA control beverage by at least about 1%.

4. The beverage of any one of embodiments 1-3, wherein the beverage has a foam height that is less than a foam height of a RebA control beverage by at least about 1% and wherein the beverage has a foam stability that is less than a foam stability of the RebA control beverage by at least about 1%.

5. The beverage of any one of embodiments 1-4, wherein the beverage is a carbonated beverage.

6. The beverage of any one of embodiments 1-4, wherein the beverage is a non-carbonated beverage.

7. The beverage of any one of embodiments 1-6, wherein the beverage has a pH in the range of about 2.2 to about 7.5.

8. The beverage of any one of embodiments 1-7, wherein the foam height of the beverage is less than the foam height of the Reb A control beverage by about 1% to about 50%.

9. The beverage of any one of embodiments 1-8, wherein the foam stability of the beverage is less than the foam stability of the Reb A control beverage by about 1% to about 70%.

10. The beverage of any one of embodiments 1-9, wherein the beverage provides a Brix in the range of about 0.5 to about 14 in terms of sucrose.

11. The beverage of any one of embodiments 1-10, wherein Reb A is present in a concentration of about 100 ppm to about 700 ppm.

12. The beverage of any one of embodiments 1-11, wherein the at least one foam suppressing agent is present in a concentration of about 1 ppm to about 300 ppm.

13. The beverage of any one of embodiments 1-12, wherein the at least one foam suppressing agent is present in a concentration of about 25 ppm to about 100 ppm.

14. The beverage of any one of embodiments 1-11, wherein the at least one foam suppressing agent is present in an amount of about 0.0001% v/v to about 0.1% v/v.

15. The beverage of any one of embodiments 1-11, wherein the ratio of Reb A to the at least one foam suppressing agent ranges from about 20:1 to about 1:5.

16. The beverage of any one of embodiments 1-15, wherein the beverage comprises Reb A and Reb E.

17. The beverage of embodiment 16, wherein Reb E is present in a concentration ranging from about 1 ppm to about 200 ppm.

18. The beverage of embodiment 16 or 17, wherein Reb E is present in a concentration of about 25 ppm to about 100 ppm.

19. The beverage of embodiments 16, wherein Reb E is present in an amount of about 0.0001% v/v to about 0.1% v/v.

20. The beverage of embodiments 16, wherein the ratio of Reb A to Reb E ranges from about 20:1 to about 1:5.

21. The beverage of any one of embodiments 1-20, wherein the beverage comprises Reb A and Reb C.

22. The beverage of embodiment 21, wherein Reb C is present in a concentration ranging from about 1 ppm to about 200 ppm.

23. The beverage of embodiment 21 or 22, wherein Reb C is present in a concentration of about 25 ppm to about 100 ppm.

24. The beverage of embodiment 21, wherein Reb C is present in an amount ranging from about 0.0001% v/v to about 0.1% v/v.

25. The beverage of embodiment 21, wherein the ratio of Reb A to Reb C ranges from about 20:1 to about 5:1.

26. The beverage of any one of embodiments 1-25, wherein the beverage comprises Reb A and stevioside.

27. The beverage of embodiment 26, wherein stevioside is present in a concentration ranging from about 1 ppm to about 200 ppm.

28. The beverage of embodiment 26 or 27, wherein stevioside is present in a concentration of about 25 ppm to about 100 ppm.

29. The beverage of embodiment 26, wherein stevioside is present in an amount of about 0.0001% v/v to about 0.1% v/v.

30. The beverage of embodiment 26, wherein the ratio of Reb A to stevioside ranges from about 20:1 to about 1:5.

31. The beverage of any one of embodiments 1-30, wherein the beverage comprises Reb A and rubusoside.

32. The beverage of embodiment 31, wherein rubusoside is present in a concentration ranging from about 1 ppm to about 200 ppm.

33. The beverage of embodiment 31 or 32, wherein rubusoside is present in a concentration of about 25 ppm to about 100 ppm.

34. The beverage of embodiment 31, wherein rubusoside is present in an amount ranging from about 0.0001% v/v to about 0.1% v/v.

35. The beverage of embodiment 31, wherein the ratio of Reb A to rubusoside is about 20:1 to about 5:1.

36. A beverage comprising Reb A, and at least one foam suppressing agent, comprising Reb E, stevioside, rubusoside, Reb C, or any combination thereof, wherein Reb A is present in a concentration of about 100 ppm to about 700 ppm and wherein the at least one foam suppressing agent is present in a concentration of about 25 ppm to about 300 ppm.

37. The beverage of embodiment 36, wherein the beverage has a foam height that is less than a foam height of a Reb A control carbonated beverage by about 1% to about 50%.

38. The beverage of embodiment 36 or 37, wherein the beverage has a foam stability that is less than a foam stability of the Reb A control carbonated beverage by about 1% to about 70%.

39. The beverage of any one of embodiments 36-38, wherein the beverage is carbonated.

40. The beverage of any one of embodiments 36-39, wherein the at least one foam suppressing agent is present in a concentration of about 25 ppm to about 100 ppm.

41. The beverage of any one of embodiments 36-40, wherein the at least one foam suppressing agent is Reb E.

42. A throw syrup comprising Reb A, and at least one foam suppressing agent comprising Reb E, stevioside, rubusoside, Reb C, or any combination thereof, wherein Reb A is present in a concentration of about 500 ppm to about 7000 ppm, and wherein the at least one foam suppressing agent is present in a concentration of about 5 ppm to about 1000 ppm.

43. The throw syrup of embodiment 42, wherein the at least one foam suppressing agent is present in a concentration of about 125 ppm to about 1000 ppm.

44. The throw syrup of embodiment 42 or 43, wherein when the throw syrup is added to a liquid medium to form a beverage, the beverage has one or more of the following characteristics:
(i) a foam height that is less than a foam height of a Reb A control beverage by at least about 1%; and
(ii) a foam stability that is less than a foam stability of the RebA control beverage by at least about 1%.

45. The throw syrup of embodiment 44, wherein the beverage is a carbonated beverage and the RebA control beverage is a RebA control carbonated beverage.

46. The throw syrup of embodiment 44 or 45, wherein the beverage has a pH in the range of about 2.2 to about 7.5.

47. The throw syrup of any one of embodiments 44-46, wherein the beverage has a Brix in the range of about 0.5 to about 14 in terms of sucrose.

48. The throw syrup of any one of embodiments 42-47, wherein the throw syrup comprises Reb E.

49. The throw syrup of any one of embodiments 42-48, wherein the throw syrup comprises stevioside.

50. The throw syrup of any one of embodiments 42-49, wherein the throw syrup comprises rubusoside.

51. The throw syrup of any one of embodiments 42-50, wherein the throw syrup comprises Reb C.

52. The throw syrup of embodiment 44, wherein the beverage has a foam height that is less than a foam height of a Reb A control carbonated beverage by about 1% to about 50%.

53. The throw syrup embodiment 44, wherein the beverage has a foam stability that is less than a foam stability of the Reb A control carbonated beverage by about 1% to about 70%.

### EXAMPLES

### Example 1

### Evaluating Foam Height and Stability of a Beverage Containing Reb a Alone and in Combination with Foam Suppressing Steviol Glycosides

The foam height and foam stability of a Reb A control beverage, and the foam suppressing properties of Reb E, Stevioside, Rubusoside, and Reb C were evaluated in a model beverage system comprising a buffer of pH 3. Sample formulation containing Reb A alone and in combination with Reb E, Stevioside, Rubusoside, or Reb C, at concentrations listed in Tables 1 and 2, were prepared.

TABLE 1
Composition of sample formulations

| | Sample name | | | | | | |
|---|---|---|---|---|---|---|---|
| | pH 3 Buffer | | | | | | |
| | Solution | Reb A | Reb A | Reb E | Stevioside | Rubusoside | Reb C |
| Ingredients | % | % | (660 ppm) | % | % | % | % |
| DI Water | 99.851 | 99.791 | 99.791 | 99.785 | 99.785 | 99.785 | 99.791 |
| Citric Acid | 0.113 | 0.113 | 0.113 | 0.113 | 0.113 | 0.113 | 0.113 |
| Sodium Citrate | 0.016 | 0.016 | 0.016 | 0.016 | 0.016 | 0.016 | 0.016 |
| Potassium Sorbate | 0.020 | 0.020 | 0.020 | 0.020 | 0.020 | 0.020 | 0.020 |
| Reb A | — | 0.060 | 0.066 | 0.060 | 0.060 | 0.060 | 0.060 |
| Reb E | — | — | — | 0.006 | — | — | — |
| Stevioside | — | — | — | — | 0.006 | — | — |
| Rubusoside | — | — | — | — | — | 0.006 | — |
| Reb C | — | — | — | — | — | — | 0.006 |
| Total | 100 | 100 | 100 | 100 | 100 | 100 | 100 |

TABLE 2
Concentration of steviol glycosides in the sample formulations

| | Steviol glycoside concentration |
|---|---|
| Sample name | in formulation (ppm) |
| pH3 buffer solution | 0 |
| Reb A | 600 ppm Reb A |
| Reb A (660 ppm) | 660 ppm Reb A |
| Reb E | 600 ppm Reb A + 60 ppm Reb E |
| Stevioside | 600 ppm Reb A + 60 ppm stevioside |
| Rubusoside | 600 ppm Reb A + 60 ppm rubusoside |
| Reb C | 600 ppm Reb A + 60 ppm Reb C |

The formulations were prepared as follows: 15 ml of solution was transferred into a 50 ml centrifuge tube. Each of the sample solutions medium shear with a tissue tearor (7 mm diameter probe) for 30 seconds. After mixing was stopped, the highest foam volume (ml) was recorded. At the same time, the time needed for complete degradation of the foam was recorded. The samples were run in triplicate and the average of the three values was taken. The results from the tissue tearor measurement of foam height described herein correlate with industry standards, such as the method described U.S. application Ser. No. 12/563,261.

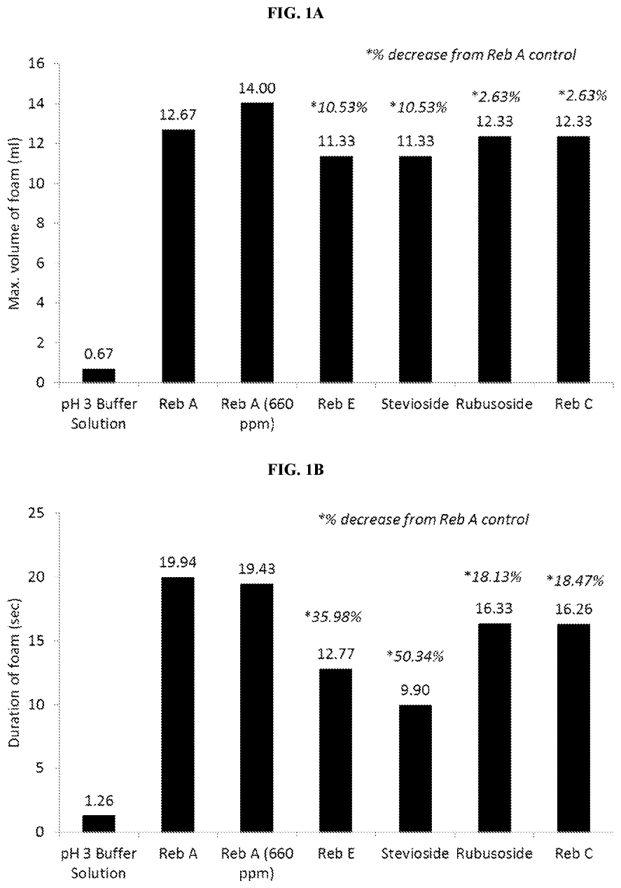

FIGS. 1A and 1B show the foam height and foam stability of beverage formulations containing Reb A. These figures show that Reb A imparts significant foam height and foam stability, even in the absence of carbonation. Further, as shown in FIG. 1B, when certain steviol glycosides (Reb E, Stevioside, Rubusoside, and/or Reb C) are added to a Reb A beverage as a foam suppressing agent, the resulting beverage had lower foam height and foam stability compared to formulations containing only Reb A. Therefore, the addition of these steviol glycosides to a formulation containing Reb A can reduce the height and stability of foam in that formulation.

### Example 2

### Evaluating the Foam Height and Foam Stability of Reb A in a Carbonated Beverage with Steviol Glycosides

Throw syrup solutions containing 1200 ppm total steviol glycosides were prepared as described below in Tables 3 and 4. The concentrations of different steviol glycosides in the throw syrup solutions and the final beverage are listed in Tables 3 and 4.75g of concentrated syrup was placed in a 10 oz glass bottle and 225g of refrigerated Vintage sparkling seltzer water was poured into the stevia syrup. The bottle was closed immediately with a plastic soda cap. The finished solution in this bottle is referred to as a 1+3 throw, meaning it is 1 part syrup and 3 parts carbonated water. It was ensured that all seltzer water used had the same lot number and came from a can to ensure similar carbonation levels. The seltzer water was always kept refrigerated to preserve the carbonation. The finished beverage was inverted twice very slowly to gently mix the syrup into the carbonated water to create a uniform solution. After all finished beverages were prepared, they were stored in the refrigerator (40° F.) over night until measurements were taken.

TABLE 3
Concentration of steviol glycoside
in throw syrup and final beverage

| | Steviol glycoside | Steviol glycoside |
|---|---|---|
| | concentration | concentration |
| Sample | in throw syrup (ppm) | in final beverage (ppm) |
| Water | 0 | 0 |
| Reb A | Reb A: 1200 | Reb A: 300 |
| Reb M | Reb M: 1200 | Reb M: 300 |
| Reb E | Reb E: 1200 | Reb E: 300 |
| 75% Reb A:25% | Reb A: 900 | Reb A: 225 |
| Reb E | Reb E: 300 | Reb E: 75 |
| 50% Reb A:50% | Reb A: 600 | Reb A: 150 |
| Reb E | Reb E: 600 | Reb E: 150 |
| 25% Reb A:75% | Reb A: 300 | Reb A: 75 |
| Reb E | Reb E: 900 | Reb E: 225 |

TABLE 4
Beverage formulations containing Reb A

| | Sample name | | | | | | |
|---|---|---|---|---|---|---|---|
| Ingredients | | | | | 75% Reb | 50% Reb | 25% Reb |
| (%) | Water | Reb A | Reb M | Reb E | A:25% Reb E | A:50% Reb E | A:75% Reb E |
| DI Water | 100.000 | 99.880 | 9.880 | 99.880 | 99.880 | 99.880 | 99.880 |
| Reb A | — | 0.120 | — | — | 0.090 | 0.060 | 0.030 |
| Reb M | — | — | 0.120 | — | — | — | — |
| Reb E | — | — | — | 0.120 | 0.030 | 0.060 | 0.090 |
| Total | 100.000 | 100.000 | 100.000 | 100.000 | 100.000 | 100.000 | 100.000 |

A 1000 ml graduated cylinder was rinsed out with DI water. A sample was pulled from the refrigerator and the cap was unscrewed. The 1000 ml graduated cylinder was placed upside down, over the neck of the bottle to create a tight seal. When ready for measurements, the graduated cylinder was quickly inverted with the bottle attached 180° to allow all the liquid to pour out from the bottle into the graduated cylinder. Once the beverage was completely poured from the bottle, the maximum foam height (ml) was recorded and a timer was started to measure the foam stability (seconds). 300 ml was subtracted from the total foam height measurement because the beverage started at 300 ml. The timer for the foam stability measurement was stopped when a break in the foam formed at the top and the finished beverage could be seen. The 1000 ml graduated cylinder was cleaned in between samples.

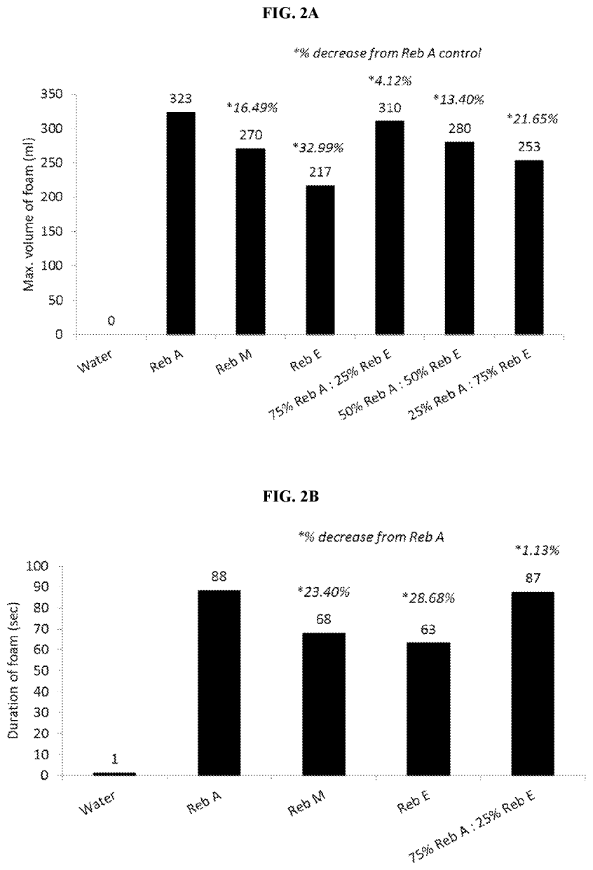

As shown in FIGS. 2A and 2B, carbonated beverages containing steviol glycosides, such as Reb M and Reb E, had noticeably lesser foam height and foam stability than formulations containing only Reb A. Increasing the ratio of Reb E to Reb A resulted in corresponding reductions in foam height. Together, these results showed that the addition of Reb E or Reb M to a carbonated beverage containing Reb A can suppress foaming in that beverage.

1. A beverage comprising Reb A, and at least one foam suppressing agent comprising Reb E, stevioside, rubusoside, Reb C, or any combination thereof, wherein the beverage has one or more of the following characteristics:
(i) a foam height that is less than a foam height of a RebA control beverage by at least about 1%, and
(ii) a foam stability that is less than a foam stability of the RebA control beverage by at least about 1%.

2. The beverage of claim 1, wherein the beverage is a carbonated beverage.

3. The beverage of claim 1, wherein the beverage is a non-carbonated beverage.

4. The beverage of claim 1, wherein the beverage has a pH in the range of about 2.2 to about 7.5, a Brix in the range of about 0.5 to about 14 in terms of sucrose, or any combination thereof.

5. The beverage of claim 1, wherein the foam height of the beverage is less than the foam height of the Reb A control beverage by about 1% to about 50%.

6. The beverage of claim 1, wherein the foam stability of the beverage is less than the foam stability of the Reb A control beverage by about 1% to about 70%.

7. The beverage of claim 1, wherein Reb A is present in a concentration of about 100 ppm to about 700 ppm.

89. The beverage of claim 1, wherein the at least one foam suppressing agent is present in a concentration of about 1 ppm to about 300 ppm, about 1 ppm to about 200 ppm, or 25 ppm to about 100 ppm.

9. The beverage of claim 1, wherein the at least one foam suppressing agent is present in an amount of about 0.0001% v/v to about 0.1% v/v.

10. The beverage of claim 1, wherein the ratio of Reb A to the at least one foam suppressing agent ranges from about 20:1 to about 1:5 or 20:1 to about 5:1.

11. The beverage of claim 1, wherein the foam suppressing agent is selected from Reb E, Reb C, stevioside, and rubusoside.

12. A beverage comprising Reb A, and at least one foam suppressing agent, comprising Reb E, stevioside, rubusoside, Reb C, or any combination thereof, wherein Reb A is present in a concentration of about 100 ppm to about 700 ppm and wherein the at least one foam suppressing agent is present in a concentration of about 25 ppm to about 300 ppm.

13. The beverage of claim 12, wherein the beverage has a foam height that is less than a foam height of a Reb A control carbonated beverage by about 1% to about 50%.

14. The beverage of claim 12, wherein the beverage has a foam stability that is less than a foam stability of the Reb A control carbonated beverage by about 1% to about 70%.

15. The beverage of claim 12, wherein the beverage is carbonated.

16. The beverage of claim 12, wherein the at least one foam suppressing agent is present in a concentration of about 25 ppm to about 100 ppm.

17. A throw syrup comprising Reb A, and at least one foam suppressing agent comprising Reb E, stevioside, rubusoside, Reb C, or any combination thereof, wherein Reb A is present in a concentration of about 500 ppm to about 7000 ppm, and wherein the at least one foam suppressing agent is present in a concentration of about 5 ppm to about 1000 ppm.

18. The throw syrup of claim 17, wherein the at least one foam suppressing agent is present in a concentration of about 125 ppm to about 1000 ppm.

19. The throw syrup of claim 17, wherein when the throw syrup is added to a liquid medium to form a beverage, wherein the beverage has one or more of the following characteristics:
(i) a foam height that is less than a foam height of a Reb A control beverage by at least about 1%; and
(ii) a foam stability that is less than a foam stability of the RebA control beverage by at least about 1%.
